(19) United States
(12) Patent Application Publication
(10) Pub. No.: US 2005/0019567 A1
(43) Pub. Date: Jan. 27, 2005

(54) Process for producing silicon carbide fibrils and product

(75) Inventor: Richard D. Nixdorf, Oak Ridge, TN (US)

Correspondence Address: PITTS AND BRITTIAN P C, P O BOX 51295, KNOXVILLE, TN, 37950-1295, US

(73) Assignee: ReMaxCo Technologies, Inc., Oak Ridge, TN (US)

(21) Appl. No.: 10/896,591

(22) Filed: Jul. 22, 2004

Related U.S. Application Data
(60) Provisional application No. 60/489,817, filed on Jul. 24, 2003.

(51) Int. Cl. B32B 9/00

(52) U.S. Cl. 428/367; 427/255.28; 427/595; 428/698; 428/336

(57) ABSTRACT

A process for the production of ceramic fibrils comprising the steps of subjecting a quantity of a catalyst for the conversion of silicon and carbon to silicon carbide under conditions of elevated temperature and the presence of a gaseous precursor for silicon and carbon, in a reaction vessel, to heating by microwave energy to a temperature not in excess of about 1300° C. for a time sufficient to disassociate said precursor into at least silicon and carbon, saturation of the catalyst with the disassociated components of the gaseous precursor and resultant growth of silicon carbide fibrils on the reaction vessel.

### CROSS-REFERENCE TO RELATED APPLICATIONS

This application is a non-provisional application based on Provisional application Ser. No. 60/489,817, filed Jul. 24, 2003, entitled: Production of Silicon Carbide Fibrils Using Microwaves, on which application priority is claimed and the entirety of which is incorporated herein by reference.

### STATEMENT REGARDING FEDERALLY SPONSORED RESEARCH OR DEVELOPMENT

This invention was at least in part sponsored by the U.S. Department of Energy through Subcontract No. X-SZ337V and the U.S. Government may own certain rights in and to the present invention.

### FIELD OF INVENTION

The present invention relates to the production of silicon carbide fibrils and specifically to the production of silicon carbide fibrils employing microwave-based vapor-liquid-solid (VLS) techniques. “Fibrils” as the term is employed herein refers to single crystal ceramic (silicon carbide, in particular) needles. As noted hereinafter, such fibrils may range between about 0.001 to about 20 micrometers in diameter, and/or between about 10 and about 10,000 micrometers in length.

### BACKGROUND OF INVENTION

Very fine diameter silicon-carbide (SiC) fibrils have excellent high-temperature properties that make them attractive for use in a variety of high-temperature applications such as reinforcements in metals and ceramics such as the use of SiC fibrils as reinforcements for Al₂O₃, for example, and high-temperature filter media. Key properties of interest include an elastic modulus of 84×10⁶ psi (579 GPa), a tensile strength of 2,300 ksi (15.8 GPa) and good oxidation, chemical and creep resistance at temperatures to 1600° C.

SiC fibrils have been proposed as reinforcements in fiber-reinforced silicon-carbide matrix composite heat-exchanger tubes, which would be fabricated using chemical vapor infiltration (CVI). Long fibrils can be spun and CVI coated for the high-temperature tubes. In addition to this application, fibrils are being considered to solve material challenges including improving the creep strength of combustion-chamber refractory tiles, producing high-temperature filter media for combustion gases and improving the toughness of refractory metals.

Also, a need exits for SiC fibrils in commercial applications including reinforcing CVI silicon carbide for heat management in silicon-carbide computer circuit boards, replacing hazardous SiC whiskers with a non-respirable product in metal-cutting tools and using SiC fibrils as high-temperature filter media in diesel exhaust, chemical processing, and fossil energy-plant emissions.

The production of SiC fibrils (VLS, or vapor-liquid-solid, whiskers) has been considered since at least about 1965. The major limitations of the current state-of-the-art fibril growth are the high temperatures required (1600 to 1700° C., the slow fibril growth rate (˜0.17 mm/hr) and the large quantity of excess of expensive methyl trichlorosilane (MTS) gas, which is wasted. The commercial process is complicated by the processing of large quantities of hydrogen gas at high temperatures and the generation of corrosive hydrochloric acid.

### BRIEF DESCRIPTION OF THE FIGURES

FIG. 1 is a schematic representation of a microwave-based reaction vessel useful in the process of the present invention;

FIG. 2 is a graphic presentation of a typical computer thermodynamic analysis on the raw materials system of one embodiment of the process of the present invention;

FIG. 3 is a schematic flow diagram of a typical embodiment of the process of the present invention;

FIG. 4 is a photograph of a reaction zone during microwave-based silicon carbide fibril growth, the glowing annulus being the catalyst layer reacting to microwave energy;

FIG. 5 is an electron micrograph of silicon carbide fibril growth employing MTS precursor in the present process;

FIG. 6 is an electron micrograph of a single crystal silicon carbide fibril grown employing MTS precursor in the present process;

FIG. 7 is an electron micrograph of a silicon carbide fibril grown employing CVD4000 precursor in the present process; and,

FIG. 8 is an electron micrograph of silicon carbide fibrils grown employing CVD4000 precursor in the present process.

### SUMMARY OF INVENTION

The present inventor has developed a novel microwave-based process for the production of VLS silicon carbide-fibrils. In the present process, a catalyst in a reaction vessel disposed in a microwave-heated reactor, is heated to an elevated temperature while a gaseous precursor is introduced into the reaction vessel. The gaseous precursor dissociates and the carbon and silicon components thereof are dissolved into the catalyst. The catalyst saturates and precipitates silicon carbide onto the surface of the reaction vessel in the form of fibrils. The process yields fibril growth rates of at least about 0.75 mm/hr, which is an improvement of approximately 4.4 times faster than the best known graphite furnace runs of the prior art.

Employing the present process, SiC fibrils may be produced using either MTS (methyl trichlorosilane or Starfire CVD4000 (an oligomeric precursor for the chemical vapor deposition of silicon-carbide having the basic formula of [SiH₂—CH₂]ₙ) produced by Starfire Systems) as a feed-gas precursor. Each of these precursors produces silicon carbibe fibrils at temperatures of less than about 1200° C. The Starfire CVD4000 produces fibrils at temperatures as low as 800° C. without the use of hydrogen and without producing the hazardous hydrochloric acid associated with the use of MTS as a precursor.

### DETAILED DESCRIPTION OF INVENTION

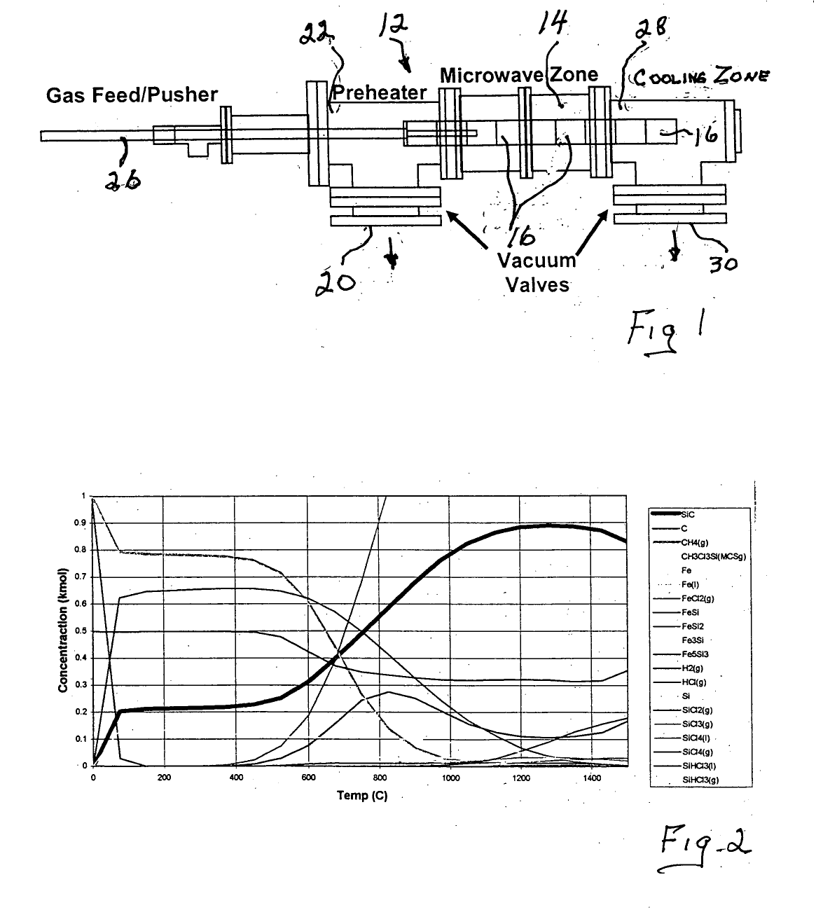

Briefly, in accordance one aspect of the present invention, there is employed a semi continuous, microwave-heated, vacuum reactor 12 (FIG. 1). The design of the reactor is selected to focus the microwaves in such a manner that a maximum percentage of the microwaves are present in the catalyst/fibrils growth (reaction) zone 14, which is where the catalyst-bearing reaction vessel(s) 16 are located within the reactor. The microwaves employed react with the insulation in the reactor so that the reactor is heated by coupling of the microwaves with the insulation. As noted, the reactor focuses the microwaves on the catalyst in the reaction vessels.

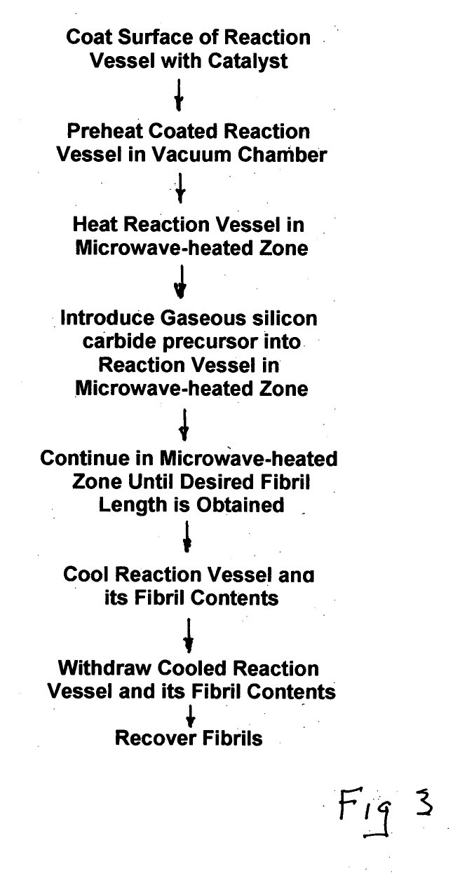

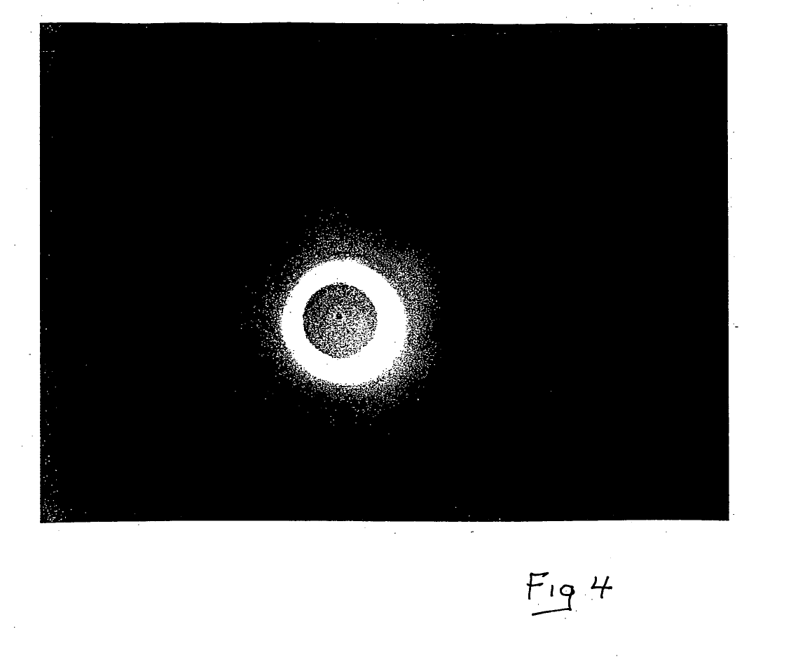

In the present process, the optimum operating parameters for the present process were determined by running a computer thermodynamic analysis on the raw materials system (see FIG. 2). As a result, and as generally depicted in the flow chart of FIG. 3, cylindrical (7.6 cm diameter×7.6 cm long) high-density aluminum-oxide reaction vessels (boats) were coated on their inner surface with a catalyst and placed into the reactor under a light vacuum. The microwave reactor was evacuated to approximately 30 torr and flushed with nitrogen gas at a pressure of 150 torr. After the flush, the furnace was backfilled with hydrogen gas to a pressure of 150 torr and maintained at less than 180 torr throughout the microwave fibril-growth run. Fibril catalyst-seed paint was prepared using metallurgical grade−325 mesh ferrous silicon mixed in a dispersant paint from YZP Corp. in a 1:1 ratio. Ferrous silicon and iron powder catalysts (and several mixtures thereof have been successfully employed in the present process.

A series of reaction vessels were fed (one at a time) through the reactor. Each boat was preheated using resistance heaters to a temperature between 700 to 900° C. (when using MTS and between 500 to 800° C. when using CVD4000), and then moved to the microwave heated reaction zone where each of two 2-kW microwave sources was stabilized at 1.8 kW. The catalyst was heated to a temperature of 1000 to 1300° C. when using MTS and to 700 to 1000° C. when using CVD4000, while introducing a mixture of MTS and hydrogen or a mixture of CVD4000 and nitrogen into the catalyst-coated area of the reaction vessel. The MTS or CVD4000 provided a source of carbon and silicon components, which saturate the catalyst and provide growth of silicon carbide fibrils in the reaction vessels, in the form of fibrils.

FIG. 4 is a photograph of the reaction zone during microwave-based silicon carbide fibril growth, the glowing annulus being the catalyst layer reacting to microwave energy.

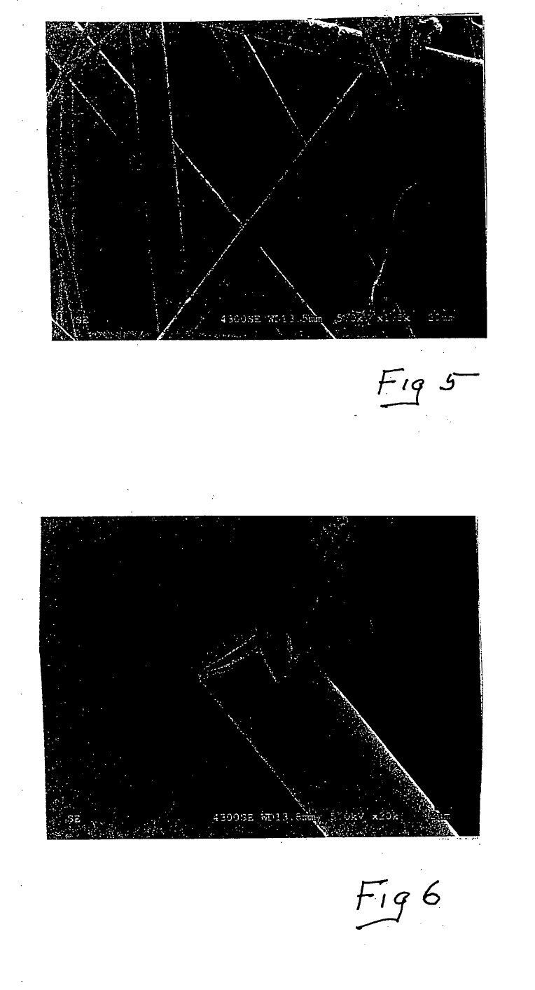

In the embodiment where MTS was employed as the precursor reaction gas, the gas was generated by bubbling hydrogen through liquid MTS in a steel container or a transparent, heated glass bubbler which allowed the operator to view the hydrogen flow through the liquid MTS and control the vapor pressure of the MTS gas. Hydrogen flow was passed through the MTS bubbler at a rate of 0.13 liters/min for a period of one to three hours. Electron micrographs of fibrils produced when employing MTS are shown in FIGS. 4 and 5.

In one embodiment of the present process, ferrous silicon was replaced with iron particles, and subsequently with a mixture of 50% ferrous silicon and 50% iron by weight. Fibrils were produced using optimal reactor operating parameters.

When using MTS precursor gas, there is generated significant quantities of hydrochloric acid in the off-gas stream. The acid destroys the vacuum system and the exhaust ducts. In accordance with a further aspect of the present process, the present inventor discovered that the MTS liquid could be replaced with CVD4000 as the silicon carbide precursor. In this embodiment, the CVD4000 was reacted in nitrogen gas rather than the more dangerous hydrogen required by the MTS liquid and gas.

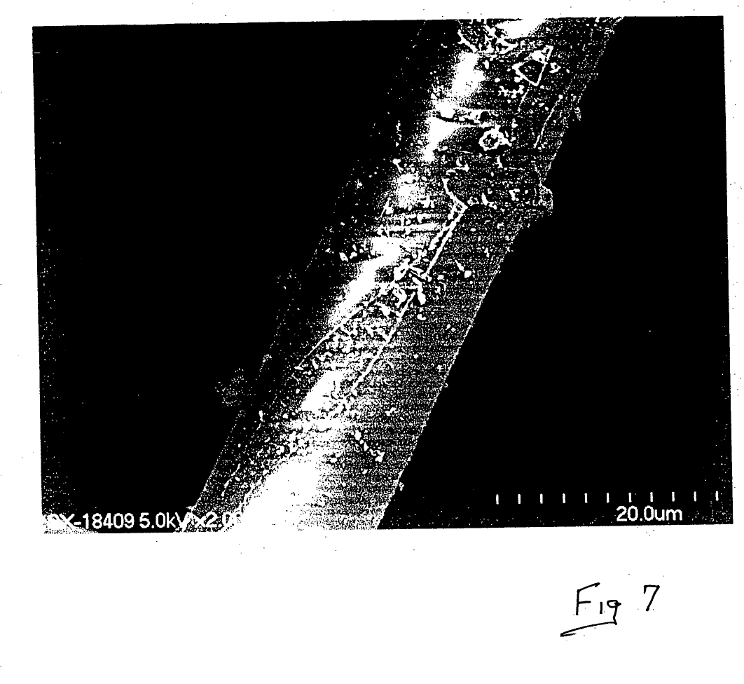

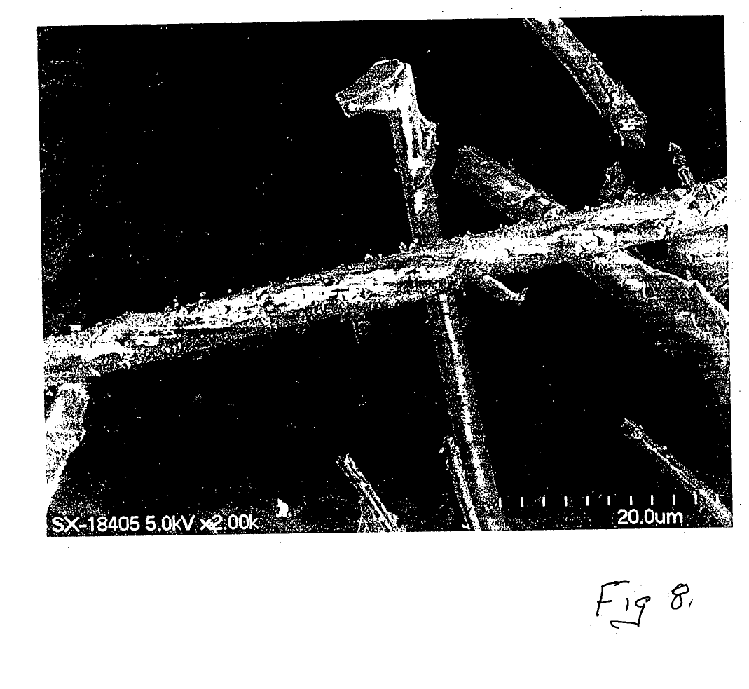

Silicon-carbide fibrils made using the CVD4000 in nitrogen produced no acid in the offgas. An unexpected advantage of the use of CVD4000 in the present invention is that fibrils grow at a temperature as low as 800° C., compared with required temperature of 1200 to 1300° C. for the MTS reaction. Fibrils 5 to 15 μm in diameter grown using the CVD4000 precursor are shown in FIGS. 7 and 8. Melt growth balls were observed with the fibrils produced using CVD4000, indicating that they were VLS.

With reference to FIG. 1, as noted, in the present process, a semi-continuous, microware heated, vacuum reactor 12 is employed. As depicted in the FIG. 1, the reactor includes a boat entry port 20 through which catalyst-bearing reaction vessels 16 are introduced into a preheat chamber 22 of the reactor and wherein the reaction vessels are preheated employing resistance heat to a temperature of about 700 to 900° C. (when using MTS) and between 501 to 800° C. (when using CVD4000). The preheated reaction vessels are moved by a pusher 26 into a microwave-heated zone 14 wherein they are heated to a selected reaction temperature while exposed to a precursor gas introduced into the reactor from an external source of precursor gas (not shown). Within the microwave zone, the precursor gas enters the catalyst-bearing reaction vessels; preferably aluminum oxide reaction vessels. The precursor gas is dissociated and the carbon and silicon components are dissolved into the catalyst. The catalyst saturates and precipitates silicon carbide onto the surface of the reaction vessel. This procedure yields fibril growth rates of 0.75 mm/hr, which is 4.4 times faster than the best known prior art graphite furnace runs. The pre-heating step of the present process is useful with respect to enhancement of the time required for the reaction vessel and its catalyst to reach a temperature close to the temperature at which silicon carbide crystal growth occurs, thereby permitting one to utilize microwave energy to raise, and maintain, the temperature of only the catalyst in a reaction vessel at that temperature at which the silicon carbide crystal growth occurs, as compared to using microwave energy to raise the temperature of the reaction vessel and its catalyst content from room temperature (for example) to the 800° C., or greater, temperature needed to commence crystal growth. This feature of the present invention provides both a time savings and energy cost savings, in that it allows one to concentrate (focus) the microwave energy upon the catalyst to raise the temperature of the catalyst, as opposed to using the microwave energy to heat, and maintain, the reaction vessel and/or other components of the reactor at the relatively higher temperature required to facilitate silicon carbide crystal growth.

The reaction vessel containing the formed silicon fibrils is withdrawn from the microwave zone into a cooling zone 28 where the temperature of the reaction vessel and its contents are reduced to about room temperature. The cooled reaction vessels with their contents are removed via an exit port 30. In this process the preheat, microwave reaction, and cooling zones are held under a vacuum.

In a typical process, cylindrical aluminum oxide reaction vessels are coated, on their inner surface, with a catalyst and placed into the reactor under a light vacuum. Several catalyst options have been employed, including ferrous silicon, iron powder and several mixtures thereof. A series of reaction vessels travel, one at a time, through the reactor. Each catalyst-bearing reaction vessel is first preheated with resistance heaters to 850 degrees C. to 900 degrees C. as measured by a Type K thermocouple. Each reaction vessel is then moved, in turn, to the microwave heated reaction zone. The catalyst in a reaction vessel is heated to the required temperature, measured by a Mikron M90-Q infrared. Pyrometer while the precursor gas is introduced into the catalyst-coated area of the boat. The precursor gas forms the carbon and silicon components, which dissolve into the catalyst to saturation and resultant growth of silicon carbide in the form of fibrils.

The optimum operating parameters for the operational parameters of the reactor, using MTS, were determined by running a computer thermodynamic analysis on the raw material system. As may be seen from FIG. 2, maximization of the silicon carbide produced with minimization of the raw material consumed, using MTS, occurs at a temperature of about 1200° C.

The fibril catalyst seed-paint was prepared using metallurgical grade, −325 mesh, ferrous silicon mixed in a dispersant paint purchased fro YZP Corporation, in a 1:1 ratio. The paint was applied in a 0.1 mm thick coating on the interior diameter of a 7.6 cm diameter by 7.6 cm long high-density aluminum oxide cylindrical reaction vessel. When the paint dried, the reaction vessels were loaded in the vacuum chamber of the microwave reactor.

The microwave reactor was evacuated by vacuum pumps to approximately 30 mTorr, and then flushed with nitrogen gas at a pressure of 150 Torr. After the nitrogen flush, the furnace was backfilled with hydrogen gas to a pressure of 150 Torr and maintained at less than 180 Torr throughout the microwave fibril growth run. The preheat zone resistance heaters were stabilized at 800 degrees C. and held there throughout the run. Each of two 1-KW microwave sources was stabilized at 1.8-KW. Hydrogen flow through the MTS bubbler was at a rate of 0.13 liters/min for a period of one to three hours. As noted, FIG. 4 depicts the reaction zone during microwave assisted silicon carbide fibril growth, the glowing annulus being the catalyst layer reacting to the microwave energy.

In an alternative embodiment, the ferrous silicon was replaced with iron particles, then a mixture of 50% ferrous silicon and 50% iron by weight.

In some instances, it was found that the catalyst paint flaked off the tops and sides of the cylindrical reaction vessels. Whereas this situation is not critical to the process, it was cured by using flat reaction vessels, formed from high-density aluminum oxide.

Employing the microwave reactor described hereinabove, there was substituted CVD4000 in nitrogen for the MTS in hydrogen. Silicon carbide fibrils were produced using the CVD4000 in nitrogen. An unexpected advantage, beyond no acid in the off gas, was the fact that fibrils grew from the CVD4000 at 850 degrees C., as opposed to the requirement of 1200 degrees C. to 1300 degrees C. for forming fibrils when employing MTS. Fibrils grown in the CVD4000 environment are depicted in FIGS. 7 and 8. The depicted fibrils are 5 to 15 micrometers in diameter. Melt growth balls were observed indicating that the fibrils are VLS.

The present process also has the benefit of producing other highly useful reinforcements including titanium nitride, titanium diboride and titanium carbide whiskers.

Whereas the present invention has been described employing language which specifies specific embodiments, it will be recognized by one skilled in the art that various substitutions or modifications may be employed without departing from the spirit of the invention. For example, in one embodiment of the reaction vessel, the preheat zone, reaction zone, and cooling zone may be incorporated into a single chamber, as desired. Thus, the present invention is intended to be limited only as set forth in the claims appended hereto.

1. A process for the production of ceramic fibrils comprising the steps of
subjecting a quantity of a catalyst for the conversion of silicon and carbon to silicon carbide under conditions of elevated temperature and the presence of a gaseous precursor for silicon and carbon in a reaction vessel, to heating by microwave energy to a temperature not in excess of about 1300° C. for a time sufficient to disassociate said precursor into at least silicon and carbon, saturation of said catalyst with said disassociated components of said gaseous precursor and resultant growth of silicon carbide fibrils on said reaction vessel.

2. The process of claim 1 wherein said catalyst comprises an iron or ferrous material.

3. The process of claim 2 wherein said catalyst, is dispersed within a paint and thereafter applied to an exposed surface of a reaction vessel.

4. The process of claim 1 wherein said reaction vessel is formed from aluminum oxide.

5. The process of claim 1 wherein said gaseous precursor comprises either methyl trichlorosilane or an oligomeric precursor for chemical vapor deposition of silicon carbide and having the basic formula of [SiH₂—CH₂]ₙ.

6. The process of claim 1 wherein said microwave reactor is heated through the reaction microwaves with an insulation disposed internally of said microwave reactor.

7. The process of claim 1 wherein said gaseous precursor is formed either by bubbling hydrogen through liquid MTS or by bubbling nitrogen through a liquid oligomeric precursor for chemical vaporization deposition of silicon carbide and having the basic formula of [SiH₂—CH₂]ₙ.

8. The process of claim 1 wherein said gaseous precursor comprises an oligomeric precursor for chemical vapor deposition of silicon carbide and having the basic formula of [SiH₂—CH₂]ₙ and nitrogen, and said reaction vessel containing said catalyst is heated employing microwave energy to a temperature between about 800 and about 900° C.

9. The process of claim 8 wherein said oligomeric precursor is initially a liquid and nitrogen gas is bubbled through said liquid to establish a flowing stream of a mixture of nitrogen gas and oligomeric precursor gas, said mixture being introduced to said catalyst disposed on said reaction vessel while in the presence of a microwave-based heated environment.

10. Silicon carbide fibrils produced by the process of claim 1.

11. The silicon carbide fibrils of claim 10 wherein said fibrils exhibit an average diameter of between about 5 and about 15 micrometers.

12. The silicon carbide fibrils of claim 11 wherein said fibrils are of the vapor-liquid-solid crystal growth mechanism for ceramics

13. The silicon carbide fibrils of claim 10 wherein said fibrils are non-toxic when inhaled by a human being.

14. A process for the production of ceramic fibrils of silicon carbide comprising the steps of
providing a reaction vessel,
depositing on an outer surface of said reaction vessel a layer of a catalyst for the reaction of silicon and carbon to silicon carbide,
preheating said reaction vessel and said catalyst disposed thereon to a temperature approximate to, but less than, the temperature at which silicon carbide crystal growth occurs,
thereafter, applying heat selectively to said catalyst on said reaction vessel employing microwave energy to selectively heat said catalyst to at least the temperature at which silicon carbide crystal growth occurs within said reaction vessel,
at least during said microwave heating step, subjecting said catalyst on said reaction vessel to an atmosphere of gaseous precursor for silicon carbide crystal growth,
continuing said microwave heating of said catalyst on said reaction vessel for a time sufficient to grow silicon carbide fibrils on said reaction vessel to a desired diameter and/or length,
cooling said reaction vessel and said fibrils thereon to about room temperature,
recovering said fibrils from said reaction vessel.

15. The method of claim 14 and including the step of maintaining said reaction vessel and its accompanying catalyst in a vacuum during preheating, microwave heating of the catalyst on the reaction vessel and cooling of the reaction vessel and its fibril contents.

16. Silicon carbide fibrils produced in accordance with the process of claim 14.

17. The silicon carbide fibrils of claim 16 where said fibrils exhibit a diameter of between about 0.001 and 20 micrometers in diameter.

18. The silicon carbide fibrils of claim 16 wherein said fibrils exhibit a length of between about 10 and about 10,000 micrometers.
